(19) United States
(12) Patent Application Publication
(10) Pub. No.: US 2013/0178967 A1
(43) Pub. Date: Jul. 11, 2013

(54) METHOD AND APPARATUS FOR VIRTUALIZING AN AUDIO FILE

(71) Applicant: JAMES MENTZ, GAINESVILLE, FL (US)

(72) Inventor: JAMES MENTZ, GAINESVILLE, FL (US)

(73) Assignee: BIT CAULDRON CORPORATION, Gainesville, FL (US)

(21) Appl. No.: 13/735,752

(22) Filed: Jan. 7, 2013

Related U.S. Application Data
(60) Provisional application No. 61/584,038, filed on Jan. 6, 2012.

(51) Int. Cl. G06F 3/16

(52) U.S. Cl. CPC G06F 3/16
USPC 700/94

(57) ABSTRACT

Embodiments of the subject invention relate to a method and apparatus for virtualizing an audio file. The virtualized audio file can be presented to a user via, for example, ear-speakers or headphones, such that the user experiences a change in the user's perception of where the sound is coming from and/or 3D sound. Embodiments can utilize virtualization processing that is based on head rotated transfer functions (HRTF's) or other processing techniques that can alter where the user perceives the sounds of the music file to originate from. A specified embodiment provides Surround Sound virtualization with DTS Surround Sensations software. Embodiments can utilize the 2-channel audio transmitted to the headphones.

### CROSS-REFERENCE TO RELATED APPLICATION

The present application claims the benefit of U.S. Provisional Application Ser. No. 61/584,038, filed Jan. 6, 2012, which is hereby incorporated by reference in its entirety, including any figures, tables, or drawings.

### BACKGROUND OF INVENTION

Music is typically recorded for presentation in a concert hall, with the speakers away from the listeners and the artists. Many people now listen to music with in-ear speakers or headphones. The music recorded for presentation in a concert hall, when presented to users via in-ear speakers or headphones, often sounds like the music originates inside the user's head.

Providing virtualized audio files to a headphone user can allow the user to experience the localization of certain sounds, such as 3D sound, over a pair of headphones. Such virtualization can be based on head related transfer function (HRTF) technology or other audio processing that results in the user perceiving sounds originating from two or more locations in space, and preferably from a wide range of positions in space.

### BRIEF SUMMARY

Embodiments of the subject invention relate to a method and apparatus for virtualizing an audio file. The virtualized audio file can be presented to a user via, for example, ear-speakers or headphones, such that the user experiences a change in the user's perception of where the sound is coming from and/or 3D sound. Embodiments can utilize virtualization processing that is based on head related transfer functions (HRTF's) or other processing techniques that can alter where the user perceives the sounds of the music file to originate from. A specified embodiment provides Surround Sound virtualization with DTS Surround Sensations software. Embodiments can utilize the 2-channel audio transmitted to the headphones.

Such virtualization can add an effect of the sounds from the audio, or music, file originating from one or more specific locations. As an example, virtualization can add the effect of a “virtual” concert hall such that, once virtualized, presentation of the music to the user via in-ear speakers or headphones results in the user perceiving the sounds as if the sounds come from speakers outside the user's head. In other words, the virtualization of the audio file can pull the originating location of the sound out of the user's head and away from the user's headphones, such that the user can have the sensation of the music not coming from the headphones. Virtualizing an audio file, or an existing music library, can allow a user to get surround sound, or other virtualization effects, with any headphones.

### DETAILED DISCLOSURE

Embodiments of the subject invention relate to a method and apparatus for virtualizing an audio file. The virtualized audio file can be presented to a user via, for example, ear-speakers or headphones, such that the user experiences a change in the user's perception of where the sound is coming from and/or 3D sound. Embodiments can utilize virtualization processing that is based on head rotated transfer functions (HRTF's) or other processing techniques that can alter where the user perceives the sounds of the music file to originate from. A specified embodiment provides Surround Sound virtualization with DTS Surround Sensations software. Embodiments can utilize the 2-channel audio transmitted to the headphones.

Such virtualization can add an effect of the sounds from the audio, or music, file originating from one or more specific locations. As an example, virtualization can add the effect of a “virtual” concert hall such that, once virtualized, presentation of the music to the user via in-ear speakers or headphones results in the user perceiving the sounds as if the sounds come from speakers outside the user's head. In other words, the virtualization of the audio file can pull the originating location of the sound out of the user's head and away from the user's headphones, such that the user can have the sensation of the music not coming from the headphones. Virtualizing an audio file, or an existing music library, can allow a user to get surround sound, or other virtualization effects, with any headphones.

Embodiments of the subject invention relate to a method and apparatus for providing a virtualized audio file. The user can utilize embodiments of the subject method and system to virtualize audio files from a variety of sources, such as a hard drive, iPod, MP3 players, websites, or other location where the user can access such an audio file. In a specific embodiment, the user can select a music file, for example from a website, and prior to receiving the music file can select to have the music file virtualized, for example via another website or processing system, and then receive the virtualized music file. A specific embodiment provides virtualization via the cloud, meaning that a user transmits, or commissions the transmission of, a music file offsite, for example via the internet, and the virtualization is accomplished at an offsite location, and then the virtualized music file is returned to the user for presentation to the user.

A specific embodiment incorporates an algorithm that allows the music, or audio, files and the virtualized audio files to be transferred, and/or processed, at a high compression rate in order to maintain the virtualization information and/or other information in the audio files and/or virtualized audio files.

Specific embodiments allow virtualization to be achieved by uploading an existing music selection and receiving a virtualized version. A specific embodiment allows a user to select a song from a hard drive, upload the song, wait for the song to be virtualized, where an optioned indicator or some optional form of entertainment is provided while virtualization is in process, and download the virtualized song.

Further embodiments allow batch virtualization via an application, providing the option to download a virtualized song file or have a virtualized song file streamed back live. In an embodiment, streaming back the virtualized song can be done without a payment, while obtaining the file of the virtualized song file requires a payment or subscription. End-users can be allowed to compare the original and virtualized song by transitioning between the original song and the virtualized song.

In an embodiment, virtualization software is written in C for Windows, such that the software receives waveform audio file format (WAV) files in and transmits WAV files out.

### EMBODIMENTS

Embodiment 1. A method for virtualizing an audio file, comprising:
receiving a request for a virtualized audio file;
acquiring an audio file, wherein virtualization of the audio file will produce the virtualized audio file;
virtualizing the audio file to produce the virtualized audio file, wherein virtualizing the audio file changes where a user listening to the virtualized audio file perceives sounds from the virtualized audio file originate from compared with the user listening to the audio file; and
providing the virtualized audio file in response to the request.

Embodiment 2. The method according to embodiment 1, wherein the audio file comprises a right channel signal and a left channel signal, wherein the virtualized audio file comprises a virtualized right channel signal and a virtualized left channel signal, wherein when the user listens to the virtualized right channel signal via a right ear of the user and listens to the virtualized left channel signal via a left ear of the user, the user perceives sounds from the virtualized audio file to originate from a different spatial location than when the user listens to the right channel signal via the right ear of the user and the listens to the left channel signal via the left ear of the user.

Embodiment 3. The method according to embodiment 1, wherein receiving a request for a virtualized audio file comprises the user submitting the request for the virtualized audio file to a website.

Embodiment 4. The method according to embodiment 3, wherein acquiring the audio file comprises the user providing the audio file to the website.

Embodiment 5. The method according to embodiment 3, wherein acquiring the audio file comprises the website acquiring the audio file prior to receiving the request.

Embodiment 6. The method according to embodiment 3, wherein acquiring the audio file comprises the website acquiring the audio file after receiving the request.

Embodiment 7. The method according to embodiment 6, wherein the website acquires the audio file from another website.

Embodiment 8. The method according to embodiment 1, wherein virtualizing the audio file comprises processing the audio file via head related transfer functions.

Embodiment 9. The method according to embodiment 3, wherein providing the virtualized audio file comprises the website transferring the virtualized audio to the user.

Embodiment 10. The method according to embodiment 9, wherein the website streams the virtualized audio file to the user.

Embodiment 11. The method according to embodiment 9, wherein the website downloads the virtualized audio file to the user.

Embodiment 12. The method according to embodiment 1, wherein providing the virtualized audio file is accomplished at a high compression rate.

Embodiment 13. The method according to embodiment 1, further comprising: receiving a payment from the user.

Embodiment 14. The method according to embodiment 1, wherein providing the virtualized audio file requires the user to have a subscription.

Embodiment 15. The method according to embodiment 1, further comprising: allowing the user to compare the audio file and the virtualized audio file by listening to the audio file and the virtualized audio file.

Embodiment 16. The method according to embodiment 1, wherein virtualizing the audio file is accomplished via software written in C for Windows.

Embodiment 17. The method according to embodiment 16, wherein the software receives the audio file in waveform audio file format and the software outputs the virtualized audio file in waveform audio file format.

Embodiment 18. The method according to embodiment 4, wherein the user provides the audio file to the website from a hard drive, MP3 player, or iPod.

Embodiment 19. The method according to embodiment 4, wherein the user provides the audio file to the website from another website.

Embodiment 20. A non-transitory computer-readable medium containing a set of instructions to cause a computer to perform a method comprising:
receiving a request for a virtualized audio file;
acquiring an audio file, wherein virtualization of the audio file will produce the virtualized audio file;
virtualizing the audio file to produce the virtualized audio file, wherein virtualizing the audio file changes where a user listening to the virtualized audio file perceives sounds from the virtualized audio file originate from compared with the user listening to the audio file; and
providing the virtualized audio file in response to the request.

Aspects of the invention, such as uploading a music file, receiving a music file, virtualizing a music file, transmitting a virtualized music file, and/or downloading a virtualized music file, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method for virtualizing an audio file, comprising:
receiving a request for a virtualized audio file;
acquiring an audio file, wherein virtualization of the audio file will produce the virtualized audio file;
virtualizing the audio file to produce the virtualized audio file, wherein virtualizing the audio file changes where a user listening to the virtualized audio file perceives sounds from the virtualized audio file originate from compared with the user listening to the audio file; and
providing the virtualized audio file in response to the request.

2. The method according to claim 1, wherein the audio file comprises a right channel signal and a left channel signal, wherein the virtualized audio file comprises a virtualized right channel signal and a virtualized left channel signal, wherein when the user listens to the virtualized right channel signal via a right ear of the user and listens to the virtualized left channel signal via a left ear of the user, the user perceives sounds from the virtualized audio file to originate from a different spatial location than when the user listens to the right channel signal via the right ear of the user and the listens to the left channel signal via the left ear of the user.

3. The method according to claim 1, wherein receiving a request for a virtualized audio file comprises the user submitting the request for the virtualized audio file to a website.

4. The method according to claim 3, wherein acquiring the audio file comprises the user providing the audio file to the website.

5. The method according to claim 3, wherein acquiring the audio file comprises the website acquiring the audio file prior to receiving the request.

6. The method according to claim 3, wherein acquiring the audio file comprises the website acquiring the audio file after receiving the request.

7. The method according to claim 6, wherein the website acquires the audio file from another website.

8. The method according to claim 1, wherein virtualizing the audio file comprises processing the audio file via head related transfer functions.

9. The method according to claim 3, wherein providing the virtualized audio file comprises the website transferring the virtualized audio to the user.

10. The method according to claim 9, wherein the website streams the virtualized audio file to the user.

11. The method according to claim 9, wherein the website downloads the virtualized audio file to the user.

12. The method according to claim 1, wherein providing the virtualized audio file is accomplished at a high compression rate.

13. The method according to claim 1, further comprising:
receiving a payment from the user.

14. The method according to claim 1, wherein providing the virtualized audio file requires the user to have a subscription.

15. The method according to claim 1, further comprising:
allowing the user to compare the audio file and the virtualized audio file by listening to the audio file and the virtualized audio file.

16. The method according to claim 1, wherein virtualizing the audio file is accomplished via software written in C for Windows.

17. The method according to claim 16, wherein the software receives the audio file in waveform audio file format and the software outputs the virtualized audio file in waveform audio file format.

18. The method according to claim 4, wherein the user provides the audio file to the website from a hard drive, MP3 player, or iPod.

19. The method according to claim 4, wherein the user provides the audio file to the website from another website.

20. A non-transitory computer-readable medium containing a set of instructions to cause a computer to perform a method comprising:
receiving a request for a virtualized audio file;
acquiring an audio file, wherein virtualization of the audio file will produce the virtualized audio file;
virtualizing the audio file to produce the virtualized audio file, wherein virtualizing the audio file changes where a user listening to the virtualized audio file perceives sounds from the virtualized audio file originate from compared with the user listening to the audio file; and
providing the virtualized audio file in response to the request.
